(19) United States
(12) Patent Application Publication
(10) Pub. No.: US 2023/0246210 A1
(43) Pub. Date: Aug. 3, 2023

(54) SYSTEMS AND METHODS TO OPTIMIZE A FUEL RECIRCULATION LOOP IN A FUEL CELL STACK

(71) Applicants: CUMMINS INC, Columbus, IN (US); HYDROGENICS CORPORATION, Mississauga (CA)

(72) Inventors: Amir AHMADZADEGAN, Waterloo (CA); Richard J. ANCIMER, Toronto (CA); Eero Andresson Aherma TEENE, Hamilton (CA)

(21) Appl. No.: 18/157,612

(22) Filed: Jan. 20, 2023

Related U.S. Application Data
(60) Provisional application No. 63/305,557, filed on Feb. 1, 2022.

(51) Int. Cl. H01M 8/04746; H01M 8/0438; H01M 8/04089

(52) U.S. Cl. CPC H01M 8/04783; H01M 8/04432; H01M 8/04097; H01M 8/04104; H01M 2008/1095

(57) ABSTRACT

The present disclosure generally relates to systems and methods for operating a fuel cell system including a three-port differential pressure switch in a recirculation loop of the fuel cell system comprising a blower and an ejector. A sensor in the three-port differential pressure switch is activated when a pressure ratio of a first pressure difference and second pressure difference exceeds a threshold ratio.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/305,557 filed on Feb. 1, 2022, the entire disclosure of which is hereby expressly incorporated herein by reference.

### TECHNICAL FIELD

The present disclosure generally relates to systems and methods for optimizing a fuel recirculation loop in a fuel cell or fuel cell stack by implementing a differential pressure switch.

### BACKGROUND

Several fuel cells are assembled into a fuel cell stack and operated to provide power or energy for industrial use. In many mobility applications it is very advantageous to assemble one or more fuel cells or fuel cell stacks to achieve a volumetric power density that better allows for improved vehicle integration.

Reactants supplied to the fuel cell include fuel (e.g., hydrogen, such as pure hydrogen) supplied at an anode and an oxidant (e.g., oxygen) supplied at a cathode. The anode is typically supplied with hydrogen from highly compressed gaseous or liquefied hydrogen stored in onboard tanks. The fuel cell or fuel cell stack may generate electricity in the form of direct current (DC) from electrochemical reactions involving the reactants.

The fuel is exhausted as a fuel exhaust from a fuel cell stack outlet and recirculated back to the anode through an anode inlet. The fuel exhaust recirculated back to the anode includes both fuel and water and recirculated to the anode inlet includes through a recirculation loop. The recirculation loop typically comprises an ejector and/or a blower or pump. The fuel exhaust is recirculated at a recirculation rate that is based on specified excess fuel targets such as an excess fuel ratio or an entrainment ratio (ER). The entrainment ratio (ER) is defined as the ratio of a mass flow rate of a low pressure stream (e.g., a secondary mass flow rate) to a mass flow rate of a high pressure stream (e.g., a primary mass flow rate).

A method to increase the efficiency of the fuel cell or fuel cell stack includes an efficient use of the blower or pump. The blower or pump in the recirculation loop may be used only when passive flow through the ejector will not be enough to meet the entrainment ratio of the fuel cell system comprising the fuel cell or fuel cell stack. Typically, a ratio of pressure differences at two sections of the recirculation loop is used to control the use of the blower or pump. However, using two differential pressure switches and an electronic controller can increase the risk of response lags, inaccuracies, and extra cost to the fuel cell system. In addition, pressure switches with proper specifications and/or sensitivity may not be available for a vast range of pressure and may affect accuracy and fluid compatibility.

Accordingly, described herein are systems and methods to control the recirculation loop in the fuel cell or fuel cell stack by optimizing the use of the blower or pump by implementing a three (3)-port differential pressure switch.

### SUMMARY

Embodiments of the present disclosure are included to meet these and other needs.

In one aspect described herein a fuel cell system comprises a three-port differential pressure switch and a sensor in the three-port differential pressure switch. The three-port differential pressure switch is in a recirculation loop of the fuel cell system comprising a blower and an ejector. The sensor in the three-port differential pressure switch is activated when a pressure ratio of a first pressure difference and second pressure difference exceeds a pressure threshold value. The first pressure difference is the difference in the between a first region of the recirculation loop and a second region of the recirculation loop and the second pressure difference is the difference in the between a third region of the recirculation loop and the second region of the recirculation loop.

In the first aspect of the present invention, the system may comprise the three-port differential pressure switch including a housing, a piston with a large head and a small head, a large seal with a first area in the large head, and a small seal with a second area in the small head. The pressure ratio may be proportional to the ratio of the second area to the first area.

In some embodiments, the ratio of the second area to the first area may be based on a nominal entrainment ratio of the fuel cell system, and the ratio of the second area to the first area may determine activation of the ejector. In some embodiments, the large seal and the small seal may separate the three-port pressure switch into a first region, a second region, and a third region. A second pressure acting on the second region may be a secondary inlet pressure of the ejector. A third pressure acting on the third region may be a primary inlet pressure of the ejector. In some embodiments, the large seal and the small seal may separate the three-port pressure switch into a first region, a second region, and a third region. A first pressure acting on the first region may be a primary inlet pressure of the ejector. A second pressure acting on the second region may be a secondary inlet pressure of the ejector. A third pressure acting on the third region may be an outlet pressure of the ejector.

In some embodiments, the three-port differential pressure switch may include a spring between the large head of the piston and an inner seat on the housing, and the spring may comprise a spring force to overcome friction of the large seal and the small seal. The three-port differential pressure switch may be switched on when a force on the large head is greater than a force on the small head.

In some embodiments, the three-port differential pressure switch may include a spring between the large head of the piston and an outer seat on the housing, and the spring may have a spring force to overcome friction of the large seal and the small seal. The three-port differential pressure is switched on when difference between a force on the large head and a force on the small head is lesser than zero.

In some embodiments, the first region of the recirculation loop may be an outlet of the ejector, the second region of the recirculation loop may be a secondary inlet of the ejector, and the third region of the recirculation loop may be a primary inlet of the ejector. In some embodiments, the three-port differential pressure may include a spring with a spring force, and activation of the three-port differential pressure may depend on the spring force. In some embodiments, the three-port differential pressure switch may be switched on at a nominal operating point comprising a current density of about 0.2 A/cm² and below. In some embodiments, the three-port differential pressure switch may be configured to operate under transient pressure conditions.

According to a second aspect, described herein, is a method of operating a fuel cell stack system comprises operating a three-port differential pressure switch comprising a piston with a large head and a small head, a large seal with a first area in the large head, and a small seal with a second area in the small head, optimizing a recirculation loop in the fuel cell system based on a ratio of the second area to the first area, and operating a blower in the recirculation loop of the fuel cell system when the three-port differential pressure switch is switched on.

In some embodiments, the three-port differential pressure switch may include a spring between the large head of the piston and an outer seat on the housing, and the three-port differential pressure may be switched on when difference between force on the large head and force on the small head is lesser than zero. In some embodiments, the three-port differential pressure switch may include a spring between the large head of the piston and an inner seat on the housing, and the three-port differential pressure switch may be switched on when force on the large head is greater than force on the small head.

In some embodiments, the method of operating the fuel cell system may be used at varying ambient conditions. In some embodiments, the three-port differential pressure switch may be functional at steady state operating conditions of the fuel cell system or at transient operating conditions of the fuel cell system. In some embodiments, the method may comprise switching on the three-port differential pressure switch at a nominal operating point comprising a current density of about 0.2 A/cm² and below.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 illustrates a typical arrangement of the components of a fuel cell system;

FIG. 3 illustrates a fuel cell system including a three-port differential pressure switch (3DPS) in a recirculation loop;

FIG. 4 illustrates an entrainment ratio (ER) curve required by a fuel cell stack and a performance curve that an ejector can deliver in a fuel cell system;

FIG. 5 illustrates one embodiment of the three-port differential pressure switch (3DPS) including a spring between a large head of a piston and an inner seat on the housing of the 3DPS, and the pressure at the large head is an outlet pressure of the ejector (P_{c}), and the pressure at the small head is a primary inlet pressure of the ejector (Pₚ);

FIG. 6 illustrates the load balance being applied on a differential pressure switch;

FIG. 7 illustrates the load balance being applied on the differential pressure switch illustrated in FIG. 5;

FIG. 8 illustrates one embodiment of the three-port differential pressure switch (3DPS) including a spring between a large head of a piston and an outer seat on the housing of the 3DPS, and the pressure at the large head is an outlet pressure of the ejector (P_{c}), and the pressure at the small head is a primary inlet pressure of the ejector (Pₚ); and

FIG. 9 illustrates one embodiment of the three-port differential pressure switch (3DPS) including a spring between a large head of a piston and an inner seat on the housing of the 3DPS, and the pressure at the large head is a primary inlet pressure of the ejector (Pₚ), and the pressure at the small head is an outlet pressure of the ejector (P_{c}).

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods to control a recirculation loop in a fuel cell or fuel cell stack by implementing a 3-port differential pressure switch. The present systems and methods optimize the use of a blower or pump in the fuel cell or fuel cell stack.

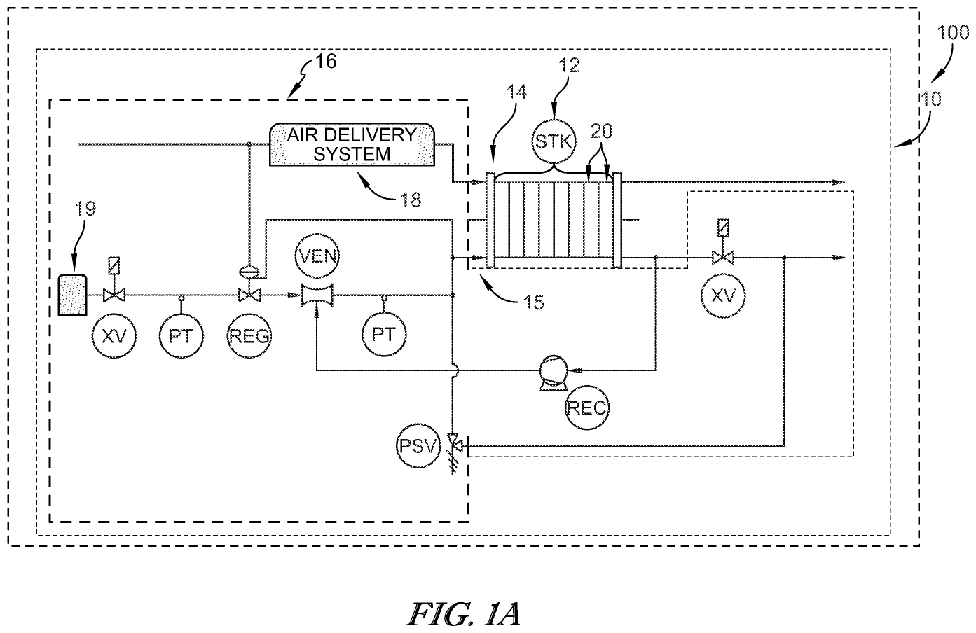

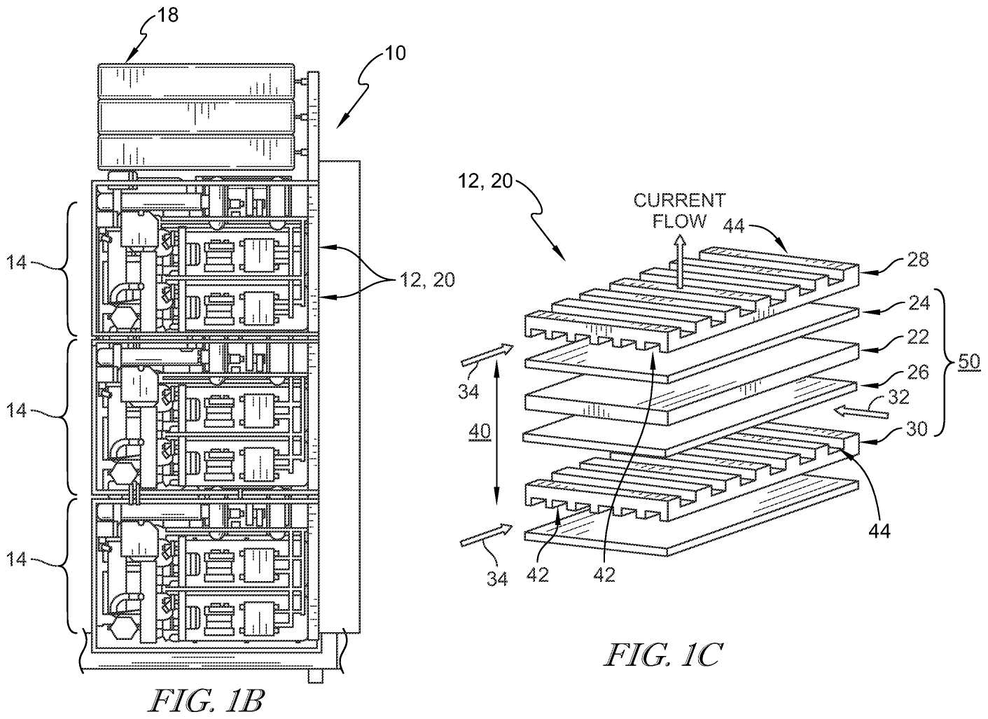

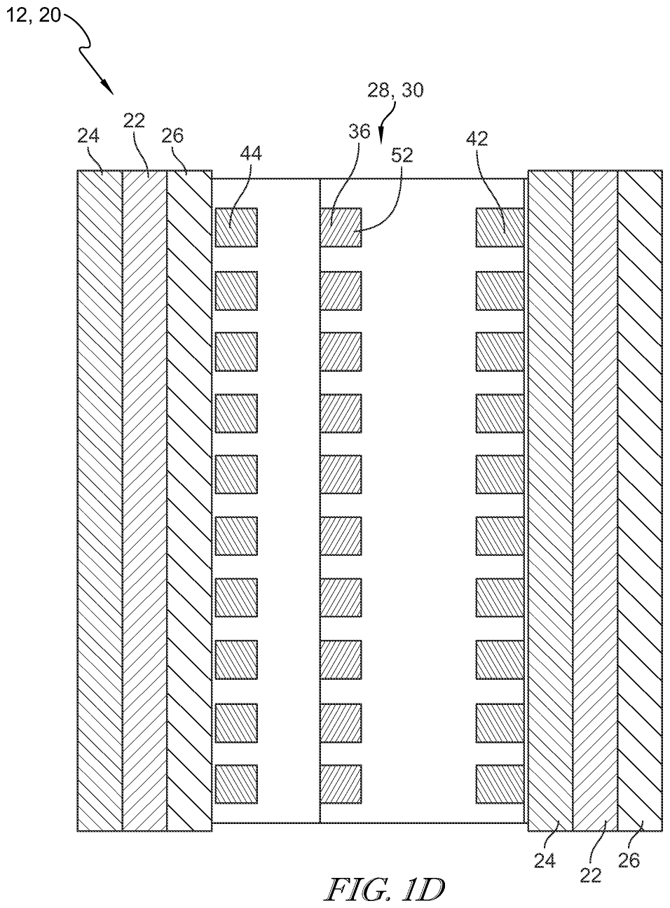

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

Fuel targets for the fuel cell system 10 may be specified as a minimum level of excess fuel required by the fuel cell 20 or fuel cell stack 12 based on operating conditions of the fuel cell 20 or fuel cell stack 12. The fuel cell 20 or fuel cell stack 12 may have an excess fuel level higher than a minimum level defined by the excess fuel target (e.g., a minimum excess fuel level), but achieving that higher fuel level may result in higher parasitic load on the fuel cell 20 or fuel cell stack 12 than a parasitic load on the fuel cell 20 or fuel cell stack 12 at the minimum level.

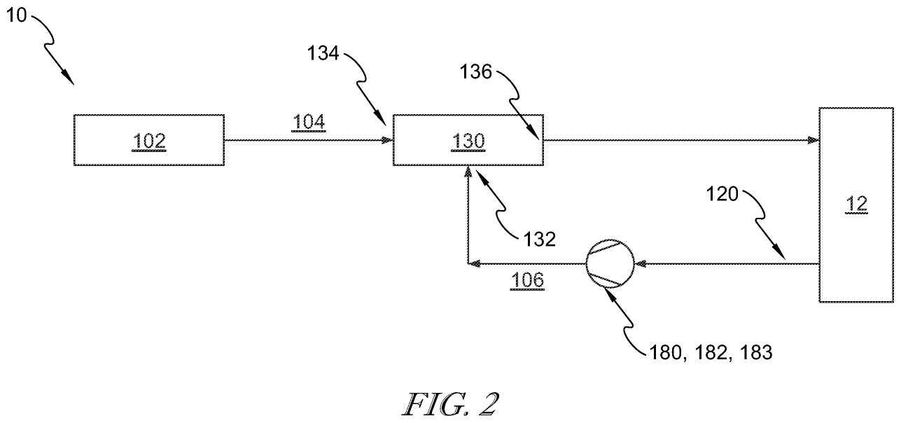

For example, an excess fuel level higher than the minimum excess fuel level may be achieved by maintaining higher than optimal fuel flow rates at an anode 15, which may lead to pressure loss in the fuel cell 20 or fuel cell stack 12. A blower 180 or pump 182 shown in FIG. 2 may function at a capacity proportional to a pressure loss in the fuel cell 20 or fuel cell stack 12 and/or to a volumetric flow rate through the blower 180 or pump 182. The blower 180 or pump 182 may use additional power to compensate for the pressure loss. However, use of additional power by the blower 180 or pump 182 typically results in an increase in parasitic load (e.g., higher parasitic load) on the fuel cell 20 or fuel cell stack 12.

FIG. 2 illustrates a typical arrangement of the components of the fuel cell system 10 including the fuel cell stack 12. A primary flow 104 from a fuel supply 102 enters a primary inlet 134 of the ejector 130 and a secondary flow 104 enters the secondary inlet 132 of the ejector 130. The secondary flow 106 may depend on the use of the blower 180 or pump 182. The blower 180 or pump 182 may be turned on by a switch 183.

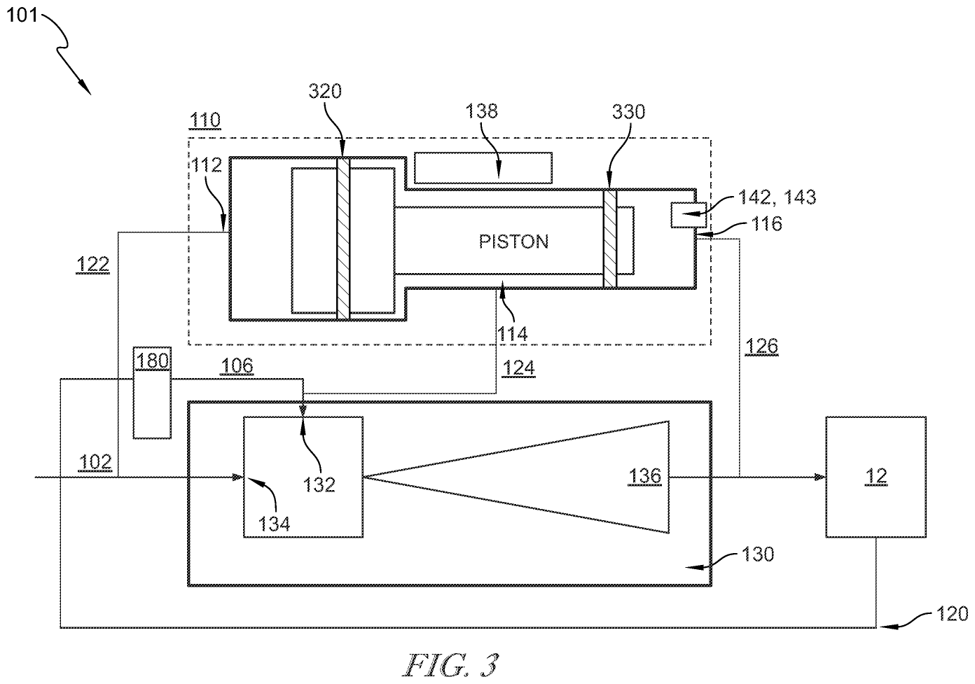

FIG. 3 illustrates a fuel cell system 101 including a three-port differential pressure switch (3DPS) 110 in a recirculation loop 120. The 3DPS 110 may have three ports 112, 114, 116 that may be connected to the recirculation loop 120 by three lines 122, 124, and 126 respectively. Pressure in different ports 112, 114, 116 of the recirculation loop 120 may be measured by the lines 122, 124, and 126.

The 3DPS 110 may comprise an integrated mechanical mechanism (e.g., an integrated electrical or mechanical controller 143) and/or may include a sensor 138 (e.g., Hall Effect sensor 138). The Hall Effect sensor 138 may be directly activated by a ratio of pressure difference between any two ports 112, 114, 116 as measured by lines 122, 124, and 126. Other embodiments may include different sensors 138 including but not limited to mechanical, electrical, and/or magnetic sensors in the 3DPS 110.

The ratio of the pressure difference between any two ports determines when the integrated electrical or mechanical controller 143 or switch 142 of the 3DPS 110 is turned on or off. The 3DPS 110 is activated when the ratio of pressure difference measured by lines 122 and 124, and by lines 124 and 126 exceeds a pressure threshold ratio value. The pressure threshold ratio value may be separately determined for transient state regimes or steady state regimes.

The pressure threshold ratio value may be determined experimentally, by computational models, and/or look-up tables. Often, the pressure threshold ratio ranges from about 0.01 to about 450, including any specific or range comprised therein. For example, the pressure threshold ratio may range from about 0.01 to about 0.1, about 0.1 to about 1, about 1 to about 50, from about 50 to about 100, from about 100 to about 200, from about 200 to about 300, from about 300 to about 400, or from about 400 to about 450. In other embodiments, the pressure threshold ratio may be below 0.1 or above 450.

Typically in the prior art, two differential pressure switches and an electronic controller are used to determine the use of the blower 180 or pump 182. The two differential pressure switches may include a first differential pressure switch that is activated based on pressure difference measured by lines 122 and 124 and a second differential pressure switch that is activated based on pressure difference measured by lines 124 and 126. However, use of two differential pressure switches can increase the risk of response lags, inaccuracies, and result in additional costs. Furthermore, differential pressure switches with proper specifications are not available for a vast range of pressure, accuracy, and fluid compatibility. In the present embodiment, the three-port DPS (3DPS) 110 is utilized instead of two differential pressure switches and/or the electronic controller.

Referring back to FIG. 3, the 3DPS 110 of the present disclosure can be used to turn the blower 180 (e.g., H₂ recirculation blower) or pump 182 on the anode 15 side of a fuel cell stack 12 on or off. The 3DPS 110 may prevent the blower 180 or pump 182 from continuously operating in situations when the ejector 130 can provide a required recirculation flow rate. The required recirculation flow rate is the required flow rate in the recirculation loop 120 based on the fuel cell system 101 operating conditions.

The 3DPS 110 may optimize the blower 180 or pump 182 operating intervals by detecting the pressure threshold ratio at which the ejector 130 cannot handle or provide the required recirculation flow rate. The optimization of the blower 180 or pump 182 by the 3DPS 110 enables the fuel cell system 101 to use the ejector's 130 capacity of passive recirculation whenever possible. Thus, the 3DPS 110 optimizes flow in the recirculation loop 120 of the fuel cell system 101.

The 3DPS 110 may be connected to the ejector 130 as shown in FIG. 3. The anode 15 side of the fuel cell stack 12, as identified in FIG. 1A, requires a certain level of extra fuel (e.g., hydrogen) than that determined by the stoichiometric consumption of the fuel cell stack 12 to be able to work efficiently. The extra fuel is provided by the ejector 130 and the recirculation loop 120. Therefore, the ejector 130 should be able to provide enough vacuum and recirculation across an entire range of operating conditions of the fuel cell system 101.

However, the efficiency of the ejector 130 drops considerably when operating at low current densities (e.g., below about 0.2 A/cm²). A recirculation flow in the recirculation loop 120 is represented by an entrainment ratio (ER). The ER is the ratio of the secondary flow rate (mₛ) of the fuel at the secondary inlet 132 of the ejector 130 to the primary flow rate (mₚ) of the fuel at the primary inlet 134 of the ejector 130.

ER=mₛ/mₚ (1)

The subscript “s” denotes the ejector secondary inlet 132, and the subscript “p” denotes the ejector primary inlet 134.

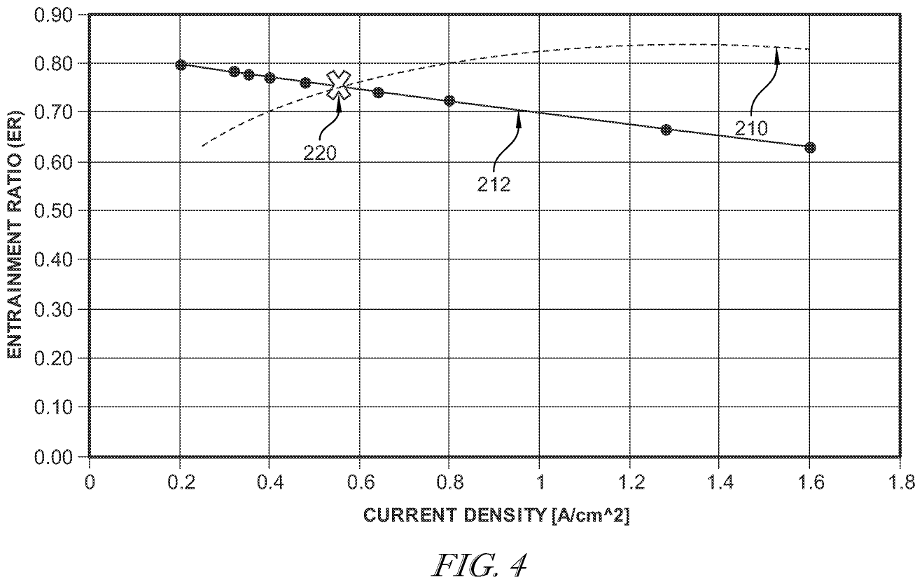

If the recirculation flow or secondary flow 106 in the recirculation loop 120 falls below the required recirculation flow rate of the fuel cell stack 12, the recirculation loop 120 requires to be boosted by the blower 180 or pump 182 to compensate for the shortcomings of the ejector 130. FIG. 4 shows an ER curve 212 required by the fuel cell stack 12 and a performance curve 210 that the ejector 130 can deliver. The 3DPS 110 may be designed to be activated at a design point 220. The 3DPS 110 may be designed to be activated when the performance of the ejector 130 falls below the fuel cell stack 12 requirement, i.e., when the recirculation flow falls below the required recirculation flow rate.

The secondary flow rate (mₛ) is a function of the pressure difference at an ejector outlet 136 (P_{c}) and the ejector secondary inlet 132 (Pₛ). The primary flow rate (mₚ) is a function of the pressure difference at the ejector primary inlet 134 (Pₚ) and the ejector secondary inlet 132 (Pₛ). The subscript “c” denotes the ejector outlet 136, the subscript “s” denotes the ejector secondary inlet 132, and the subscript “p” denotes the ejector primary inlet 134.

mₛ=f(ΔP_{c-s}) (2)

mₚ=f(ΔPₚ₋ₛ) (3)

ER=f([ΔP_{c-s}]/[ΔPₚ₋ₛ]) (4)

In some embodiments, the 3DPS 110 may be designed to operate based on the pressure differences between three points in the recirculation loop 120, the primary inlet 134, the secondary inlet 132, and the ejector outlet 136. The pressure difference that is measured by the 3DPS 110 may depend on the fuel cell stack 12 design, operating current density, target entrainment ratio, and other operating conditions of the fuel cell system 101. Additionally, a safety margin may be needed to ensure that the 3DPS 110 that is operating based on the pressure difference is functional over the entire operating range for the fuel cell system 101.

The pressure difference over which the 3DPS 110 can operate may range from about 15 kPa to about 450 kPa, including any specific pressure difference or range of pressure difference comprised therein. For example, The pressure difference over which the 3DPS 110 can operate may range from about 15 kPa to about 100 kPa, from about 100 kPa to about 200 kPa, from about 200 kPa to about 300 kPa, from about 300 kPa to about 400 kPa, or from about 400 kPa to about 450 kPa, including any pressure difference or range of pressure difference comprised therein.

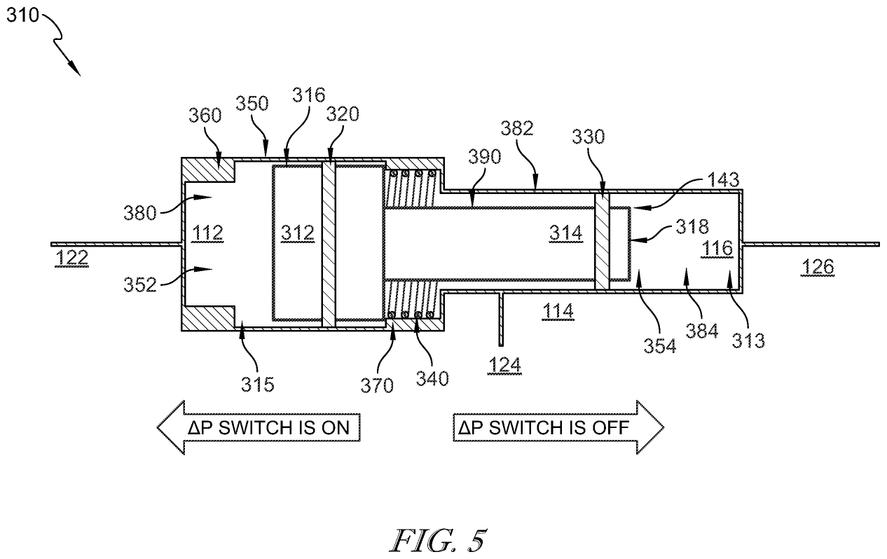

FIG. 5 illustrates one embodiment of a three-port differential pressure switch (3DPS) 310 of the present disclosure. This 3DPS 310 comprises a piston 390, a large seal 320 and a small seal 330, a spring 340, a housing 350, an outer seat 360, and/or an inner seat 370. The piston 390 includes a large head 312 and a small head 314 at ends 316 and 318, respectively.

The piston 390 can slide back and forth inside the housing 350. The large seal 320 is installed on the large head 312 of the piston 390, and the small seal 330 is installed on the small head of 314 of the piston 390. The seals 320 and 330 may be designed to close any gap between piston heads 312, 314 and corresponding counter bores 313, 315 of the housing 350. Similar to 3DPS 110 shown in FIG. 3, 3DPS 310 may comprise the integrated mechanical mechanism (e.g., an integrated electrical or mechanical controller 143) and may include the Hall Effect sensor 138.

The spring 340 may be designed to apply a force on the large head 312 from inner seat 370 of the housing 350 towards the outer seat 360 (see FIG. 5). The housing 350 holds the piston 390, the seals 320, 330, and the spring 340 together. The housing 350 may contain a working fluid 352 that is rated for a working pressure of the piston 390. The housing 350 may be compatible with the working fluid 352. An internal space 354 of the housing 350 is divided into three sections or regions 380, 382, and 384 by the seals 320, 330.

The line 122 may be connected to the port 112 located in region 380. Line 122 may be located upstream of the large head 312 of the piston 390. Line 124 is connected to the port 114 located in region 382. Line 124 may be located between the large head 312 and the small head 314 of the piston 390. Line 126 is connected to the port 116 located in region 384. Line 126 may be located downstream of the small head 314 of the piston 390.

The piston 390 is typically seated, positioned, or located on the outer seat 360 of the housing 350 when there is no fluid pressure due to the force applied by the spring 340. The piston 390 is typically seated, positioned, or located on the inner seat 370 of the housing 350 when the overall forces on the piston 390 push the piston 390 towards the line 126. The spring 340 is typically at its maximum compression at this point (e.g., when the piston 390 pushes the piston 390 towards the line 126).

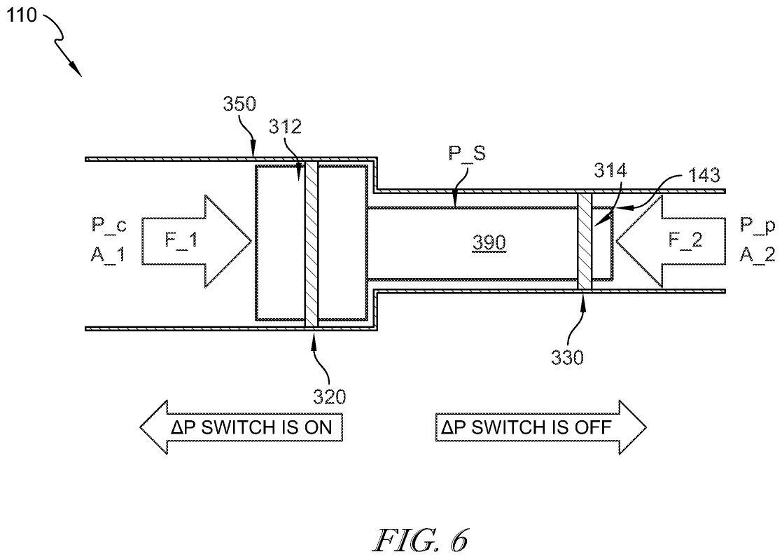

Referring to FIGS. 3 and 5, if the line 122 is connected to the ejector outlet 136, the pressure at port 112 may be the pressure at the ejector outlet 136 (P_{c}). If the line 126 is connected to the primary inlet 134 of the ejector 130, the pressure at port 116 may be the pressure at the ejector primary inlet 134 (Pₚ). If the line 124 is connected to the secondary inlet 132 of the ejector 130, the pressure at port 114 may be the pressure at the ejector secondary inlet 132 (Pₛ). A load balance may applied on the 3DPS 110 as illustrated in FIG. 6 and as described below:

P_{c}A₁=Pₛ(A₁−A₂)+PₚA₂ (5)

A₁[P_{c}−Pₛ]=A₂[Pₚ−Pₛ] (6)

A₂/A₁=[P_{c}−P_{c}]/[Pₚ−Pₛ] (7)

ER=f([ΔP_{c-s}]/[ΔPₚ₋ₛ]) (8)

ER=f(A₂/A₁) (9)

F₁=P_{c}*A₁ (10)

F₂=Pₛ(A₁−A₂)+PₚA₂ (11)

A₁ is the area of the large seal 320, A₂ is the area of the small seal 330, P_{c} is the pressure at the ejector outlet 136, Pₚ is the pressure at the primary inlet 134, and Pₛ is the pressure at the secondary inlet 132. F₁ is the force being applied on the large head 312 of the piston 390. F₂ is the force being applied on the small head 314 of the piston 390.

When the 3DPS 110 is designed as shown on FIG. 6, the ratio A₂/A₁ may be determined such that if the ER in the fuel cell system 101 comprising the 3DPS 110 goes below an ER threshold, the resulting load acting on the piston 390 pushes it towards an ‘on’ direction. Thus, the 3DPS 110 can be used to trigger the switch 183 to turn the blower 180 or a pump 182 on or off (FIG. 1A).

The relationship between the ER threshold and pressure differentials at the inlet and outlet (e.g., 132, 134, 136) of the ejector 130 determines the structure of the 3DPS 110. If the pressure differentials acting on the area of the small seal 330 to the area of the large seal 320 (A₂/A₁) exceeds a certain pressure threshold ratio, the entrainment ratio will exceed the ER threshold. As previously described, this pressure threshold ratio may depend on the characteristics of the fuel cell stack 12 and the fuel cell system 101 and may have a range of about 0.01 to about 450, including any specific or range comprised therein.

Thus, the ratio of the area of the small seal 330 to the area of the large seal 320, A₂/A₁ may be designed or determined to make the pressure threshold ratio and ER threshold equivalent. The ratio of the area of the small seal 330 to the area of the large seal 320 (A₂/A₁) may be designed or determined at the operating point or design point 220 (FIG. 3) based on a nominal entrainment ratio. This operating point or design point 220 may be designed or determined to be at a point where the performance curve 210 of the ejector 130 crosses the ER curve 212 of the fuel cell stack 12. In one embodiment, the operating point or design point 220 may be at a current density of about 0.05 A/cm² to about 0.5 A/cm, including any specific or range of current density comprised therein. In one embodiment, the design point or the operating point may be at a nominal operating point comprising a current density of about 0.2 A/cm².

In one embodiment, if the pressure at the ejector outlet 136 (P_{c}) is about 120 kPa, the pressure at the ejector primary inlet 134 (Pₚ) is about 132.5 kPa, the pressure at the ejector secondary inlet 132 (Pₛ) is about 117.5 kPa, the ratio of the area of the small seal 330 to the area of the large seal 320, A₂/A₁, may be determined to be about 2.5 cm²/15.1 cm² or approximately about 0.17 cm². If the diameter of the small seal 330 is about 0.25 cm, the diameter of the large seal 320 may be about 0.625 cm. Similarly, if the diameter of the small seal 330 is about 0.375 cm, the diameter of the large seal 320 may be about 0.937 cm.

As seen in Table 1, if a force being applied on the small head 314 of the piston 390 (F₂) is greater than the force being applied on the large head 312 of the piston 390 (F₁), the piston 390 moves off the inner seat 370. This may happen for ER values higher than the nominal operating point comprising a current density of about 0.2 A/cm².

TABLE 1
Identifying piston movement based on differential pressure at different
operating current density.

Increasing operating current density

[symbol]

| | | | | | | | | | | | | |
|---|---|---|---|---|---|---|---|---|---|---|---|---|
| F_1 [N] | 23.8 | 23.8 | 23.8 | 23.8 | 25.4 | 25.8 | 26.5 | 27.5 | 29.7 | 33.9 | 48.3 | 49.5 |
| F_2 [N] | 23.6 | 23.5 | 23.5 | 23.7 | 25.8 | 26.4 | 27.3 | 28.9 | 32.5 | 38.1 | 56.5 | 61.5 |
| F_2 − F_1 | −0.2 | −0.2 | −0.3 | 0.0 | 0.4 | 0.6 | 0.8 | 1.4 | 2.8 | 4.2 | 8.2 | 12.1 |
| dp [kPa] | 1.2 | 1.5 | 1.7 | 2.5 | 3.8 | 4.1 | 4.6 | 5.3 | 6.5 | 7.1 | 8.0 | 9.7 |

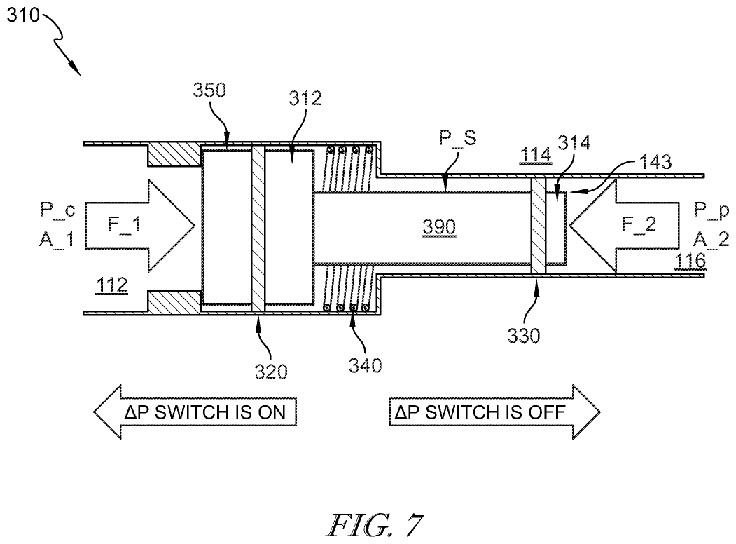

A similar force balance may be applied if the 3DPS 310 has a spring 340, the pressure at port 112 is the pressure at the ejector outlet 136 (P_{c}), the pressure at port 116 is the pressure at the ejector primary inlet 134 (Pₚ), and the pressure at port 114 is the pressure at the ejector secondary inlet 132 (Pₛ), as shown in FIG. 7. To accommodate for movement of the piston 390 off the inner seat 370, the size of the area of the large seal 320 (A₁) may be increased while keeping the area of the small seal 330 (A₂) the same size and adjusting the spring force of the spring 340. Under such conditions, the 3DPS 310 may be switched on at operating current densities lower than the nominal operating point comprising a current density of about 0.2 A/cm².

For example, if the area of the large seal 320 (A₁) is about 1.98 cm², the area of the small seal 330 (A₂) is about 0.32 cm², and the spring force of the spring 340 is about 13 N, despite a large area ratio and a high spring force, the resultant force on the piston 390 may be sufficient to overcome any friction and switch the 3DPS 310 on (Table 2). The 3DPS 310 may be switched on at the nominal operating point comprising a current density of about 0.2 A/cm² and below. The spring force of the spring 340 may be chosen such that this switching or activation point may be adjusted to be close to the nominal operating point comprising a current density of about 0.2 A/cm². The spring 340 may be designed according to the required force to ensure this switching or activation point.

TABLE 2
Determining piston movement based on differential pressure at different operating
current densities by selecting a high spring force.

Increasing operating current density

[symbol]

| | | | | | | | | | | | | |
|---|---|---|---|---|---|---|---|---|---|---|---|---|
| F_sp [N] | 13 | | | | | | | | | | | |
| F_1 [N) | 40.1 | 40.1 | 40.1 | 40.1 | 42.8 | 43.6 | 44.6 | 46.5 | 50.1 | 57.2 | 81.5 | 83.5 |
| F_2 [N] | 23.7 | 23.7 | 23.9 | 25.7 | 30.4 | 31.9 | 34.3 | 38.8 | 49.1 | 60.8 | 96.2 | 118.2 |
| F_2 − F_1 − F_sp | −3 4 | −3.4 | −3.2 | −1.4 | 0.6 | 1.4 | 2.7 | 5.3 | 12.0 | 16.6 | 27.7 | 47.7 |

| | |
|---|---|
| [symbol] | [symbol] |

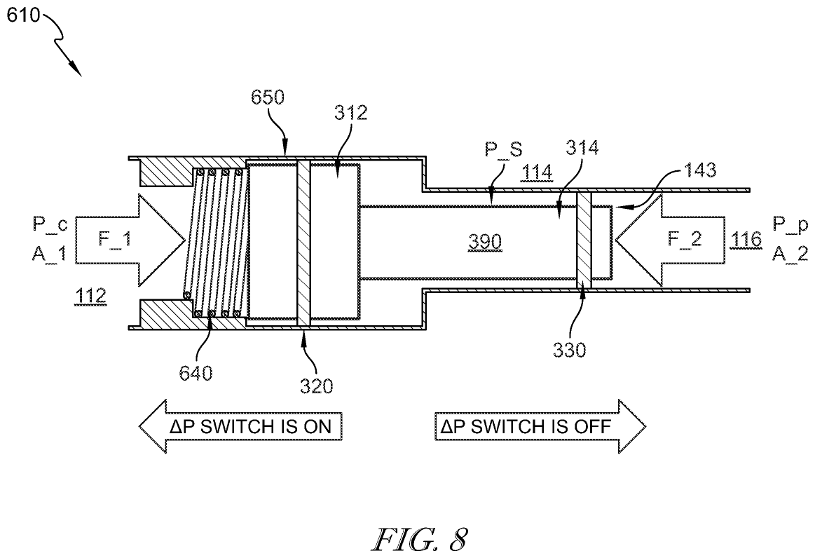

In one embodiment, the fuel cell system 101 includes a three-port differential pressure switch (3DPS) 610, as shown in FIG. 8. Similar to 3DPS 110, shown in FIG. 3, the 3DPS 610 may comprise the integrated mechanical mechanism (e.g., an integrated electrical or mechanical controller 143) and may include the Hall Effect sensor 138.

The pressure at port 112 may be the pressure at the ejector outlet 136 (P_{c}). The pressure at port 116 may be the pressure at the ejector primary inlet 134 (Pₚ). The pressure at port 114 may be the pressure at the ejector secondary inlet 132 (Pₛ).

The 3DPS 610 may be switched on when F₂−F₁ is less than zero (e.g., F₂−F₁<0). If the 3DPS 610 does not include a spring 640, the resultant force on the piston 390 may not be sufficient to overcome friction of the seals 320, 330 at low operating current densities of about 0.2 A/cm². Table 3 illustrates the condition when the 3DPS 610 includes the spring 640 with a spring force of about 4 Newton (N).

The ratio of the area of the small seal 330 to the area of the large seal 320 (A₂/A₁) may be changed when the area of the small seal 330 (A₂) is changed. If the area of the small seal 330 (A₂) is changed to about 1.6 cm², the 3DPS 610 is switched on with the nominal operating point comprising a current density of about 0.2 A/cm² and below. However, the housing 650 may be more expensive than the housing 350 of the 3DPS 310 due to the split design and tight tolerances required. The spring force of the spring 640 may be chosen to adjust the switching or activation point to be close to the nominal operating point comprising a current density of about 0.2 A/cm². The spring 640 may be designed according to the required force to ensure this switching or activation point.

TABLE 3
Determining piston movement based on differential pressure at different operating
current density by using a spring to boost the force being applied on the large head
312 of the piston 390 (F₁).

Increasing operating current density

[symbol]

| | | | | | | | | | | | | |
|---|---|---|---|---|---|---|---|---|---|---|---|---|
| F_sp [N] | 4 | | | | | | | | | | | |
| F_1 [N) | 23.8 | 23.8 | 23.8 | 23.8 | 25.4 | 25.8 | 26.5 | 27.5 | 29.7 | 33.9 | 48.3 | 49.5 |
| F_2 [N) | 23.7 | 23.7 | 23.9 | 25.7 | 30.4 | 31.9 | 34.3 | 38.8 | 49.1 | 60.8 | 96.2 | 118.2 |
| F_2 − F_1 − F_sp | −4.1 | −4.0 | −3.9 | −2.1 | 1.0 | 2.1 | 3.9 | 7.2 | 15.4 | 22.9 | 44.0 | 64.7 |

| | |
|---|---|
| [symbol] | [symbol] |

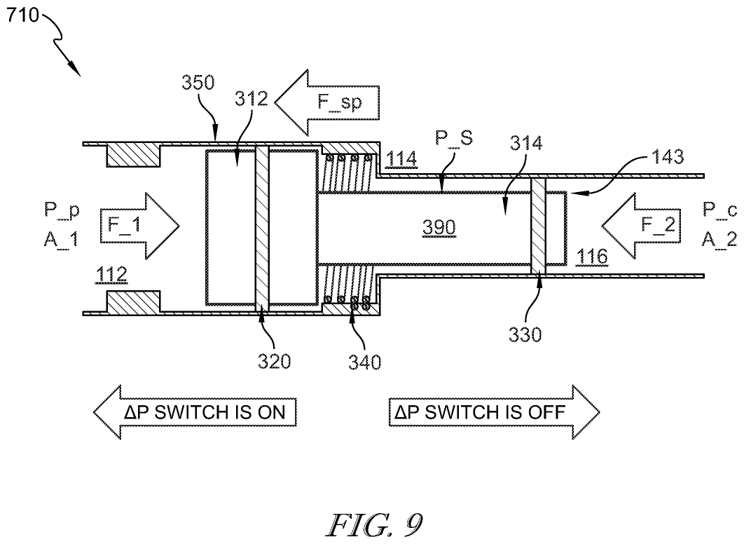

In one embodiment, the fuel cell system 101 includes a three-port differential pressure switch (3DPS) 710 as shown in FIG. 9. Similar to 3DPS 110 shown in FIG. 3, the 3DPS 710 may comprise the integrated mechanical mechanism (e.g., an integrated electrical or mechanical controller 143) and may include the Hall Effect sensor 138.

The pressure at the ports 112 and 116 may be reversed compared to that shown in FIG. 8. The pressure at port 112 may be the pressure at the ejector primary inlet 134 (Pₚ). The pressure at port 116 may be the pressure at the ejector outlet 136 (P_{c}). The pressure at port 114 may be the pressure at the ejector secondary inlet 132 (Pₛ). In some embodiments, the 3DPS 710 may not include the spring 340. Table 4 lists the forces F₁ and F₂ acting on the large head 312 and a small head 314 of the piston 390, respectively if the 3DPS 710 does not include the spring 340.

For the varying operating current densities, the trend of a resultant load on the piston 390 is based on the values of F₁ and F₂ when F₁>F₂. However, in the absence of the spring 340, the switching or activation point of the 3DPS 710 is not at about 0.2 A/cm². This occurrence is altered by the addition of the spring 340. If 3DPS 710 includes the spring 340, and the spring 340 applies a spring force of about 3 N (Fₛₚ=3 N), then F₂−F₁+Fₛₚ is as shown in Table 5.

TABLE 4
Identifying piston movement based on differential pressure at different operating
current density after reversing pressure in the ports connected to the ejector.

Increasing operating current density

[symbol]

| | | | | | | | | | | | | |
|---|---|---|---|---|---|---|---|---|---|---|---|---|
| F_1 [N] | 23.7 | 23.8 | 24.0 | 26.2 | 31.8 | 33.6 | 36.4 | 41.7 | 54.0 | 67.5 | 108.0 | 135.0 |
| F_2 [N] | 23.6 | 23.5 | 23.5 | 23.3 | 24.7 | 25.1 | 25.7 | 26.7 | 28.6 | 32.7 | 47.0 | 47.9 |
| F_2 − F_1 | −0.2 | −0.3 | −0.5 | −2.9 | −7.1 | −8.4 | −10.7 | −15.0 | −25.4 | −34.8 | −61.0 | −87.1 |

In the embodiment illustrated in FIG. 9, the 3DPS 710 is switched on or activated if the operating point falls below a certain operating current density (e.g., 0.2 A/cm²). The spring force of the spring 340 can be adjusted further to overcome any friction due to the seals 320, 330, such that the 3DPS 710 is switched on the nominal operating point comprising a current density of about 0.2 A/cm².

TABLE 5
Identifying piston movement based on differential pressure at different operating current
density after reversing pressure and using a spring with a spring force of 3 N.

Increasing operating current density

[symbol]

| | | | | | | | | | | | | |
|---|---|---|---|---|---|---|---|---|---|---|---|---|
| F_sp [N] | 3 | | | | | | | | | | | |
| F_1 [N] | 23.7 | 23.8 | 24.0 | 26.2 | 31.8 | 33.6 | 36.4 | 41.7 | 54.0 | 67.5 | 108.0 | 135.0 |
| F_2 [N] | 23.6 | 23.5 | 23.5 | 23.3 | 24.7 | 25.1 | 25.7 | 26.7 | 28.6 | 32.7 | 47.0 | 47.9 |
| F_2 − F_1 + F_sp | 2.8 | 2.7 | 2.5 | 0.1 | −4.1 | −5.4 | −7.7 | −12.0 | −22.4 | −31.8 | −58.0 | −84.1 |

[symbol]

[symbol]

In some embodiments, the forces acting on the large head 312 of the piston 390 and on the small head 314 of the piston 390 may be magnified to enable the heads 312, 314 to overcome any friction due to the seals 320, 330. The forces may be magnified by increasing the area of the large seal 320 (A₁) and the area of the small seal 330 (A₂) while maintaining the same A₂/A₁ value. For example, if the 3DPS 710 has an A₂ of 0.71 cm² and an A₁ of 4.45 cm², and the spring force of the spring 340 is increased to about 7 N, the difference in the forces is enhanced at the nominal operating point comprising a current density of about 0.2 A/cm² (Table 6).

TABLE 6
Identifying piston movement based on differential pressure at different operating current
density after reversing pressure and using a spring with a spring force of 7 N.

Increasing operating current density

[symbol]

| | | | | | | | | | | | | |
|---|---|---|---|---|---|---|---|---|---|---|---|---|
| F_sp [N] | 7 | | | | | | | | | | | |
| F_1 [N] | 53.3 | 53.5 | 53.9 | 59.0 | 71.5 | 75.4 | 81.8 | 93.6 | 121.3 | 151.7 | 242.7 | 303.3 |
| F_2 [N] | 52.9 | 52.8 | 52.7 | 52.4 | 55.6 | 56.5 | 57.7 | 59.9 | 64.3 | 73.5 | 105.5 | 107.5 |
| F_2 − F_1 + F_sp | 6.6 | 6.3 | 5.9 | 0.5 | −8.9 | −12.0 | −17.1 | −26.7 | −50.0 | −71.2 | −130.1 | −188.7 |

[symbol]

[symbol]

Since the spring 340 may aid in turning the 3DPS 710, 610, 310, 110 on, the 3DPS 710, 610, 310, 110 is normally kept in an off position. When the fuel cell system 101 starts operating, pressure at the primary inlet 134 of the ejector 130 may set the piston 390 of 3DPS 710, 610, 310, 110 to an off position, which may make the fuel cell system 101 operate in normal conditions.

Tables 7 and 8 illustrate that the 3DPS 710 can work under transient pressure conditions. Under transient conditions, the pressure across the recirculation loop 120 in the fuel cell system 101, P_{LIFT}, may be assumed constant. The pressure at port 112, Pₚ may be adjusted according to the pressure at port 116, P_{c}. The pressure at port 114 is Pₛ, and is calculated as, Pₛ=P_{c}−P_{LIFT}. If the pressure at port 116, P_{c}, increases due to ambient conditions, as shown in Table 7, the 3DPS 710 may be switched on at the nominal operating point comprising a current density of about 0.2 A/cm².

If the pressure at port 116, P_{c}, decreases due to ambient conditions, as shown in Table 8, the 3DPS 710 may be switched on at the nominal operating point comprising a current density of about 0.2 A/cm². Thus, the 3DPS 710 can be switched on at the set point or the operating current density the 3DPS 710 is designed for.

A method of optimizing the recirculation loop 120 in the fuel cell system 101 includes using a three-port differential switch (e.g., 710, 610, 310, 110). The method of optimizing the recirculation loop 120 in the fuel cell system 101 is based on the ratio of the area of the small seal 330 (A₂) to the area of the large seal 320 (A₁) in the piston 390 of the 3DPS 710, 610, 310, 110. The method of optimizing the recirculation loop 120 in the fuel cell system 101 includes using a three-port differential switch that is robust at varying ambient conditions. The method of optimizing the recirculation loop 120 in the fuel cell system 101 includes processes that do not change with varying ambient conditions. The method of optimizing the recirculation loop 120 in the fuel cell system 101 includes using a three-port differential switch that is robust at steady state and/or transient operating conditions of the fuel cell system 101.

TABLE 7
Identifying piston movement based on differential pressure at different operating current density at
high ambient pressure conditions.

Increasing operating current density

[symbol]

| | | | | | | | | | | | | |
|---|---|---|---|---|---|---|---|---|---|---|---|---|
| F_sp [N] | 7 | | | | | | | | | | | |
| F_1 [N] | 111.9 | 112.1 | 112.3 | 114.5 | 118.1 | 119.5 | 122.0 | 127.0 | 140.1 | 157.5 | 235.2 | 295.2 |
| F_2 [N] | 110.8 | 110.7 | 110.6 | 110.3 | 109.8 | 109.7 | 109.5 | 109.3 | 108.8 | 108.6 | 108.2 | 107.6 |
| F_2 − F_1 + F_sp | 5.9 | 5.6 | 5.2 | 2.8 | −1.3 | −2.8 | −5.5 | −10.8 | −24.3 | −42.0 | −121.0 | −180.6 |

| | |
|---|---|
| [symbol] | [symbol] |

TABLE 8
Identifying piston movement based on differential pressure at different operating current density at
low ambient pressure conditions.

Increasing operating current density

[symbol]

| | | | | | | | | | | | | |
|---|---|---|---|---|---|---|---|---|---|---|---|---|
| F_sp [N] | 7 | | | | | | | | | | | |
| F_1 [N] | 53.3 | 53.4 | 53.7 | 58.5 | 67.8 | 71.2 | 77.1 | 88.9 | 118.1 | 147.6 | 235.2 | 295.2 |
| F_2 [N] | 52.9 | 52.8 | 52.7 | 52.4 | 52.0 | 51.8 | 51.7 | 51.4 | 51.0 | 50.7 | 50.4 | 49.8 |
| F_2 − F_1 + F_sp | 6.6 | 6.5 | 6.0 | 1.0 | −8.9 | −12.4 | −16.4 | −30.5 | −60.1 | −89.9 | −178.8 | −238.5 |

[symbol]

[symbol]

The following described aspects of the present invention are contemplated and non-limiting:

A first aspect of the present invention relates to a fuel cell system. The fuel cell system comprises a three-port differential pressure switch and a sensor in the three-port differential pressure switch. The three-port differential pressure switch is in a recirculation loop of the fuel cell system comprising a blower and an ejector. The sensor in the three-port differential pressure switch is activated when a pressure ratio of a first pressure difference and second pressure difference exceeds a pressure threshold ratio value. The first pressure difference is the difference in the between a first region of the recirculation loop and a second region of the recirculation loop and the second pressure difference is the difference in the between a third region of the recirculation loop and the second region of the recirculation loop.

A second aspect of the present invention relates to a method of operating a fuel cell stack system. The method comprises operating a three-port differential pressure switch comprising a piston with a large head and a small head, a large seal with a first area in the large head, and a small seal with a second area in the small head, optimizing a recirculation loop in the fuel cell system based on a ratio of the second area to the first area, and operating a blower in the recirculation loop of the fuel cell system when the three-port differential pressure switch is switched on.

In the first aspect of the present invention, the system may comprise the three-port differential pressure switch including a housing, a piston with a large head and a small head, a large seal with a first area in the large head, and a small seal with a second area in the small head. The pressure ratio may be proportional to the ratio of the second area to the first area.

In the first aspect of the present invention, the ratio of the second area to the first area may be based on a nominal entrainment ratio of the fuel cell system, and the ratio of the second area to the first area may determine activation of the ejector. In the first aspect of the present invention, the large seal and the small seal may separate the three-port pressure switch into a first region, a second region, and a third region. A first pressure acting on the first region may be an outlet pressure of the ejector. A second pressure acting on the second region may be a secondary inlet pressure of the ejector. A third pressure acting on the third region may be a primary inlet pressure of the ejector. In the first aspect of the present invention, the large seal and the small seal may separate the three-port pressure switch into a first region, a second region, and a third region. A first pressure acting on the first region may be a primary inlet pressure of the ejector. A second pressure acting on the second region may be a secondary inlet pressure of the ejector. A third pressure acting on the third region may be an outlet pressure of the ejector.

In the first aspect of the present invention, the three-port differential pressure switch may include a spring between the large head of the piston and an inner seat on the housing, and the spring may comprise a spring force to overcome friction of the large seal and the small seal. The three-port differential pressure switch may be switched on when a force on the large head is greater than a force on the small head.

In the first aspect of the present invention, the three-port differential pressure switch may include a spring between the large head of the piston and an outer seat on the housing, and the spring may have a spring force to overcome friction of the large seal and the small seal. The three-port differential pressure is switched on when difference between a force on the large head and a force on the small head is lesser than zero.

In the first aspect of the present invention, the first region of the recirculation loop may be an outlet of the ejector, the second region of the recirculation loop may be a secondary inlet of the ejector, and the third region of the recirculation loop may be a primary inlet of the ejector. In the first aspect of the present invention, the three-port differential pressure may include a spring with a spring force, and activation of the three-port differential pressure may depend on the spring force. In the first aspect of the present invention, the three-port differential pressure switch may be switched on at a nominal operating point comprising a current density of about 0.2 A/cm² and below. In the first aspect of the present invention, the three-port differential pressure switch may be configured to operate under transient pressure conditions.

In the second aspect of the present invention, the three-port differential pressure switch may include a spring between the large head of the piston and an outer seat on the housing, and the three-port differential pressure may be switched on when difference between force on the large head and force on the small head is lesser than zero. In the second aspect of the present invention, the three-port differential pressure switch may include a spring between the large head of the piston and an inner seat on the housing, and the three-port differential pressure switch may be switched on when force on the large head is greater than force on the small head.

In the second aspect of the present invention, the method of operating the fuel cell system may be used at varying ambient conditions. In the second aspect of the present invention, the three-port differential pressure switch may be functional at steady state operating conditions of the fuel cell system or at transient operating conditions of the fuel cell system. In the second aspect of the present invention, the method may comprise switching on the three-port differential pressure switch at a nominal operating point comprising a current density of about 0.2 A/cm² and below.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell system comprising:
a three-port differential pressure switch in a recirculation loop of the fuel cell system comprising a blower and an ejector,
a sensor in the three-port differential pressure switch that is activated when a pressure ratio of a first pressure difference and second pressure difference exceeds a pressure threshold ratio;
wherein the first pressure difference is a difference between a first region of the recirculation loop and a second region of the recirculation loop and the second pressure difference is a difference between a third region of the recirculation loop and the second region of the recirculation loop.

2. The system of claim 1, wherein the three-port differential pressure switch includes a housing, a piston with a large head and a small head, a large seal with a first area in the large head, and a small seal with a second area in the small head, and wherein a pressure ratio is proportional to a ratio of the second area to the first area.

3. The system of claim 2, wherein the ratio of the second area to the first area is based on a nominal entrainment ratio of the fuel cell system, and wherein the ratio of the second area to the first area is configured to activate the ejector.

4. The system of claim 2, wherein the large seal and the small seal separate the three-port differential pressure switch into a first region, a second region, and a third region, and wherein a first pressure acting on the first region is an outlet pressure of the ejector, a second pressure acting on the second region is a secondary inlet pressure of the ejector, and a third pressure acting on the third region is a primary inlet pressure of the ejector.

5. The system of claim 2, wherein the large seal and the small seal separate the three-port pressure switch into a first region, a second region, and a third region, and wherein a first pressure acting on the first region is a primary inlet pressure of the ejector, a second pressure acting on the second region is a secondary inlet pressure of the ejector, and a third pressure acting on the third region is an outlet pressure of the ejector.

6. The system of claim 2, wherein the three-port differential pressure switch includes a spring between the large head of the piston and an inner seat on the housing, and wherein the spring has a spring force to overcome a friction of the large seal and the small seal.

7. The system of claim 6, wherein the three-port differential pressure switch is configured to be switched on when a force on the large head is greater than a force on the small head.

8. The system of claim 2, wherein the three-port differential pressure switch includes a spring between the large head of the piston and an outer seat on the housing, and wherein the spring has a spring force to overcome a friction of the large seal and the small seal.

9. The system of claim 8, wherein the three-port differential pressure is configured to be switched on when a difference between a force on the large head and a force on the small head is less than zero.

10. The system of claim 1, wherein the first region of the recirculation loop is an outlet of the ejector, the second region of the recirculation loop is a secondary inlet of the ejector, and the third region of the recirculation loop is a primary inlet of the ejector.

11. The system of claim 1, wherein the three-port differential pressure includes a spring with a spring force, and wherein the spring force is configured to activate the three-port differential pressure.

12. The system of claim 1, wherein the three-port differential pressure switch is configured to be switched on at a nominal operating point comprising a current density of about 0.2 A/cm² and below.

13. The system of claim 1, wherein the three-port differential pressure switch is configured to operate under transient pressure conditions.

14. A method of operating a fuel cell system comprising:
operating a three-port differential pressure switch comprising a piston with a large head and a small head, a large seal with a first area in the large head, and a small seal with a second area in the small head,
optimizing a recirculation loop in the fuel cell system based on a ratio of the second area to the first area, and
operating a blower in the recirculation loop of the fuel cell system when the three-port differential pressure switch is on.

15. The method of claim 14, comprising switching on the three-port differential pressure switch when a difference between a force on the large head and a force on the small head is lesser than zero, wherein the three-port differential pressure switch includes a spring between the large head of the piston and an outer seat on the housing.

16. The method of claim 14, comprising switching on the three-port differential pressure switch when a difference between a force on the large head is greater than a force on the small head, wherein the three-port differential pressure switch includes a spring between the large head of the piston and an inner seat on the housing.

17. The method of claim 14, comprising operating the fuel cell system at varying ambient conditions.

18. The method of claim 14, comprising operating the three-port differential pressure switch at steady state operating conditions of the fuel cell system.

19. The method of claim 14, comprising operating the three-port differential pressure switch at transient operating conditions of the fuel cell system.

20. The method of claim 14, comprising switching on the three-port differential pressure switch at a nominal operating point comprising a current density of about 0.2 A/cm² and below.
